(19) United States
(12) Patent Application Publication
(10) Pub. No.: US 2007/0070844 A1
(43) Pub. Date: Mar. 29, 2007

(54) Optical disk apparatus and a method for controlling overwrite operation thereof

(75) Inventor: Hiroyuki Hayashi, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storage, Inc., Tokyo (JP)

(21) Appl. No.: 11/540,892

(22) Filed: Sep. 28, 2006

(30) Foreign Application Priority Data
Sep. 29, 2005 (JP) 2005-283851

(51) Int. Cl. G11B 19/00

(52) U.S. Cl. 369/47.41

(57) ABSTRACT

For controlling overwrite operation within an optical disk apparatus, for enabling the overwrite operation while rotationally driving a re-writable type optical disk at a predetermined speed, determination is made on whether information recorded on the re-writable type optical disk 12 is recorded by the apparatus itself or not, when conducting the overwrite operation onto the re-writable type optical disk, and recording operation is conducted while driving the disk at the maximum speed (6×) within that apparatus, when determining that the information recorded on the re-writable type optical disk is conducted by that apparatus itself in the above, on the other hand, the recording operation is conducted while driving the disk at a speed lower (4×) than the maximum speed, when determining that the information recorded on said re-writable type optical disk is not conducted by said apparatus itself in the above, thereby providing an optical disk apparatus and a control method for overwrite operation therein, enabling the overwrite operation upon the re-writable optical disk, with maintaining the recording quality, sufficiently, even if being unequal in the recording performances between different apparatuses.

### BACKGROUND OF THE INVENTION

The present invention relates to an optical disk apparatus for enabling to perform an overwrite operation on an optical disk of rewritable type, and in particular, it relates to an optical disk apparatus, for enabling to maintain recording quality when conducting the overwrite operation upon the rewritable-type optical disk, upon which information is recorded through various kinds of apparatuses, being different in model or format thereof.

An optical disk of being so-called a disc-like optical information recording medium, such as, CD, DVD or the like, for example, is used widely, as an information recording medium of being non-contact, a large memory capacity and a low cost, and also of enabling data access at high speed, for example, for the purpose of recording/reproducing digital audio data and/or digital video data, and further in recent years is also widely used a rewritable-type optical disk, such as, DVD±RW or the like, for example.

By the way, conventionally, when conducting overwrite (hereinafter, also called by “ICOW: InterChange Over Write”) on the rewritable-type optical disk, which was overwritten by a certain optical disk apparatus, in particular, on such the rewritable-type optical disk as mentioned above, through other optical disk recording apparatus, for example, there is a drawback that Jitter is lowered due to inequality in the performances thereof between those apparatuses; i.e., an error rate obtained from that comes to be high.

Then, for example, in the following Patent Document 1 is proposed a method and an apparatus for conducting recoding on the optical disk, wherein an RID code (i.e., an identification information of the recording apparatus) remaining on the rewritable-type optical disk is read out to be compared, when conducting the overwrite upon the rewritable-type optical disk through that apparatus, while memorizing the RID code by refereeing to the recording conditions (such as, the recording speed of data, for example), within a memory portion of the apparatus. And, in case where the RID data read out is in consistent with other RID differing from that of that apparatus itself, original data is completely deleted or erased, so as to overwrite new data for it, and thereby preventing increasing of the error rate due to degradation in the Jitter. Also, when the RID code read out is not coincident with any one of plural numbers of RID codes, which are memorized in advance, on the other hand, also the original for it, but conducting OPC (Optimum Power Control: an operation for determining an optimal recording power).

[Patent Document 1] Japanese Patent Laying-Open No. 2004-310906 (2004)

### BRIEF SUMMARY OF THE INVENTION

As was mentioned above, with the method and the apparatus for recoding the optical disk relating to the conventional art described above, identification is made upon the recoding conditions of the apparatus, which records the original data, by using the RID code read out from the rewritable-type optical disk, and thereby executing the recording under the recording condition registered in advance, in the similar manner.

With such the method and the apparatus for executing the recording under the recording condition registered in advance, in the similar manner, with using the RID code (i.e., the identification information of the recording apparatus), as was the conventional art mentioned above, however there is still a drawback that the recording quality cannot be guaranteed when conducing the overwrite (ICOW), in case where there is inequality in the recording performances between different optical disk apparatuses, even within the same model registered.

Then, according to the present invention, by taking the drawback of the conventional art mentioned above into the consideration thereof, an object thereof is to provide an optical disk apparatus and a method for controlling the overwrite operation thereof, enabling the overwrite operation on the rewritable-type optical disk, even if there is inequality in the recording performances between different optical disk apparatuses within the same model, with maintaining sufficient recording quality therewith.

For accomplishing the object mentioned above, according to the present invention, firstly there is provided an optical disk apparatus, for enabling overwrite operation upon a re-writable type optical disk, comprising: a spindle motor for rotationally driving an optical disk of rewritable type, at a predetermined speed; an information recording portion for recording information, through irradiating a laser beam upon an information recording surface of said optical disk of rewritable type, which is rotationally driven by said spindle motor; an information reproducing portion for reproducing the information upon the information recording surface on said optical disk of rewritable type, through reflection light of the laser beam reflected upon the information recording surface thereof; and a controller portion for controlling operation of said spindle motor, said information recording portion and said information reproducing portion, wherein determination is made on whether information recorded on said re-writable type optical disk is conducted by said apparatus itself or not, when conducting the overwrite operation onto said re-writable type optical disk, and thereby conducting recording operation while driving said disk at a high speed within said apparatus, when determining that the information recorded on said re-writable type optical disk is conducted by said apparatus itself, on the other hand, conducting the recording operation while driving said disk at a speed lower than said high speed, when determining that the information recorded on said re-writable type optical disk is not conducted by said apparatus itself.

Further, according to the present invention, within the optical disk apparatus, as described in the above, preferably, further determination is made on presence of setup for deceleration when conducting the overwrite operation, for a kind of said optical disk, when determining that the information recorded on said re-writable type optical disk is not conducted by said apparatus itself, and thereby conducting recording operation while driving said disk at the high speed within said apparatus, when determining that no setup is made for deceleration when conducting the overwrite operation, on the other hand, conducting the recording operation while driving said disk at a speed lower than said high speed, when determining that the setup is made for deceleration when conducting the overwrite operation.

Also for accomplishing the object mentioned above, according to the present invention, there is further provided a method for controlling overwrite operation within an optical disk apparatus, for enabling the overwrite operation while rotationally driving a re-writable type optical disk at a predetermined speed, comprising the following steps of: determining on whether information recorded on said re-writable type optical disk is recorded by said apparatus itself or not, when conducting the overwrite operation onto said re-writable type optical disk; conducting recording operation while driving said disk at a high speed within said apparatus, when determining that the information recorded on said re-writable type optical disk is conducted by said apparatus itself in the above; and conducting the recording operation while driving said disk at a speed lower than said high speed, on the other hand, when determining that the information recorded on said re-writable type optical disk is not conducted by said apparatus itself in the above.

Further, according to the present invention, the method for controlling overwrite operation within an optical disk apparatus, as described in the above, when determining that the information recorded on said re-writable type optical disk is not conducted by said apparatus itself in the above, further comprises the following steps of: determining on presence of setup for deceleration when conducting the overwrite operation, for a kind of said optical disk; conducting recording operation while driving said disk at the high speed within said apparatus, when determining that no set up is made for deceleration when conducting the overwrite operation; and conducting the recording operation while driving said disk at a speed lower than said high speed, on the other hand, when determining that the setup is made for deceleration when conducting the overwrite operation.

Moreover, according to the present invention, within the optical disk apparatus and the method for controlling overwrite operation therein, as described in the above, preferably, the high speed within said apparatus is a maximum speed within said apparatus, or the presence of the setup of deceleration for the kind of said optical disk when conducing the overwrite operation is determined upon basis of width of Erase Ratio within said apparatus.

In addition thereto, according to the present invention, the optical disk apparatus, as described in the above, preferably, further comprises a memory device for memorizing the presence of the setup of deceleration when conducing the overwrite operation, which is determined, in advance, or within the optical disk apparatus, as described in the above, preferably, determination is executed upon RMD information on said re-writable type optical disk, when determining on whether the information recorded on said re-writable type optical disk is recorded by said apparatus itself or not.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing an outline structure of an optical disk apparatus, according to an embodiment of the present invention;

FIG. 2 is a view for showing an example of self-overwrite characteristics when high speed, within two (2) products of the same model, for explaining the principle of the present invention;

FIG. 3 is a view for explaining Erase Ratio within the characteristics, which are shown in FIG. 2 mentioned above;

FIG. 4 is a view for showing the overwrite characteristics, which are obtained when conducting the overwrite at a high speed (6×) through the apparatuses differing in the models thereof;

FIG. 4 is a view for showing the overwrite characteristics, which are obtained when conducting the overwrite at a low speed (4×) through the apparatuses differing in the models thereof; and

FIG. 6 is a flowchart for showing the control when the optical disk apparatus, according to the embodiment of the present invention, conducts the recording operation.

### DETAILED DESCRIPTION OF THE INVENTION

Hereinafter, embodiments according to the present invention will be fully explained by referring to the attached drawings.

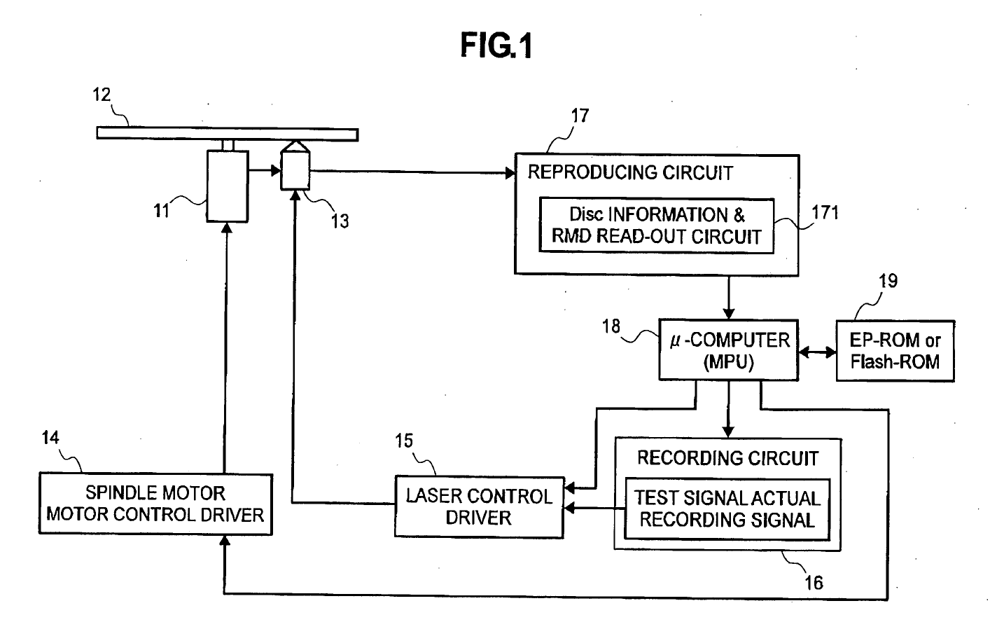

First of all, FIG. 1 shows the entire structures of an optical apparatus, according to an embodiment of the present invention.

In this FIG. 1, a reference numeral 11 depicts a spindle motor, and at a tip of rotation shaft of this spindle motor 11 is mounted an optical disk 12, being a disc-like optical information recording medium, for example, by means of a holding member, but not shown in the figure, thereby being rotationally driven at a predetermined rotation speed. On the other hand, facing to the information recording surface (i.e., the lower surface in the figure) of the optical disk 12, which is rotationally driven at the predetermined rotation speed in this manner, an optical pickup 13 is provided in a movable manner into the radial direction of the disk, and therefore, although not shown in the figure, the optical pickup 13 irradiates a laser beam generated from a light source, such as, a semiconductor laser, for example, which is provided in an inside thereof, upon the information recording surface of the optical disk through an optic system, including an objective lens therein, and further it receives a reflection light thereof, thereby conducting so-called a focusing operation and/or a tracking operation, as well as, recording or reproducing a test signal and/or an actual recording signal.

Also, a reference numeral 14 in the figure depicts so-called a driver circuit for use of controlling the spindle motor, for supplying driving current to the spindle motor 11 mentioned above. In this embodiment, it enables controlling, for example, a quad-speed (4×) and a six-speed (6×). Also, a reference numeral 15 in the figure depicts a driver circuit for use of controlling the laser, for supplying driving current to the semiconductor later, which builds up the light source of the optical pickup 13 mentioned above. Further, into this driver circuit 15 for use of controlling the laser are provided or inputted a control signal from a microcomputer 18, which will be mentioned below, and also a recording control signal from a recording circuit 16, which processes the test signal and/or the actual recording signal from an outside (though not shown in the figure, from a host computer (hereinafter, only by “host”), etc., for example), thereby controlling the recording thereof.

On the other hand, an electric signal, which is detected and outputted by the optical pickup 13 mentioned above, is conducted with a predetermined reproducing process within a reproducing circuit 17, and thereby being reproduced into a desired signal (for example, digital data), to be outputted into an outside of the apparatus, for example. Further, according to the present invention, within the reproducing circuit 17 is provided a Disc information & RMD information readout circuit 171, for reading out the Disc information & RMD information, which are recoded in a portion (for example, management information recording region or area) on the optical disk 12, upon basis of an output signal from the optical pickup 13 mentioned above.

In addition thereto, as a control unit for controlling the optical disk apparatus, which comprises such the structures as was mentioned above, there is provided so-called a microcomputer (i.e., a MPU) 18, and this control unit 18 including the microcomputer therein inputs various kinds of signals therein, through the reproducing circuit 17 mentioned above, and thereby outputting control signals to the driver circuit 14 for use of controlling the spindle motor and further the recording circuit 16 mentioned above, in addition to the driver circuit 15 for use of controlling the laser. Also, this microcomputer 18 is equipped with a memory, such as, an EP-ROM or a Flash-ROM 19, etc., to be a memory device thereof.

However, with such the information recording/reproducing apparatus including the structures as mentioned above, for a person skilled in the art, it is of course that predetermined operations can be made therein, including recording and reproducing operations of information, through already-known functions or operations thereof.

For example, test-writing operation is started within the apparatus, upon a start instruction of recording supplied from an outside thereof. Thus, the control unit (CPU) 18 transmits this instruction to the driver 14 for controlling the spindle motor, and this spindle motor control driver 14 rotates the spindle motor 11, thereby rotating the optical disk at a predetermined speed (such as, a quad-speed (4×) or a six-speed (6×), for example). Also, in this instance, the control unit (CPU) 18 gives such an indication or instruction to the driver 15 for use of controlling the laser, that it transmits a test signal to the optical pickup 13, while controlling intensity of an output of the laser beam from the semiconductor laser mentioned above to a power for recording or a power for erasing, and thereby conducting the recording or reproducing onto a test writing area or region on the optical disk 12. Thereafter, within the control unit (CPU) 18, an optimal recording power or an optimal erasing power is calculated out, and the value calculated out is transmitted to the driver 15 for use of controlling the laser. Next, the control unit (CPU) 18 gives an indication or instruction to the driver 15 for laser controlling, and at the same time, it transmits an actual recording signal to the optical pickup 13. With doing this, the optical pickup 13 enables to conduct recording or erasing, i.e., the overwrite operation (ICOW), with the optimal recording power or the optimal erasing power, which is calculated out.

By the way, with the actual optical disk apparatuses, there are inequalities or fluctuations in the recording performances thereof, of course, among the optical disk apparatuses differing from one another in the models thereof, and also among the optical disk apparatuses falling within the same model.

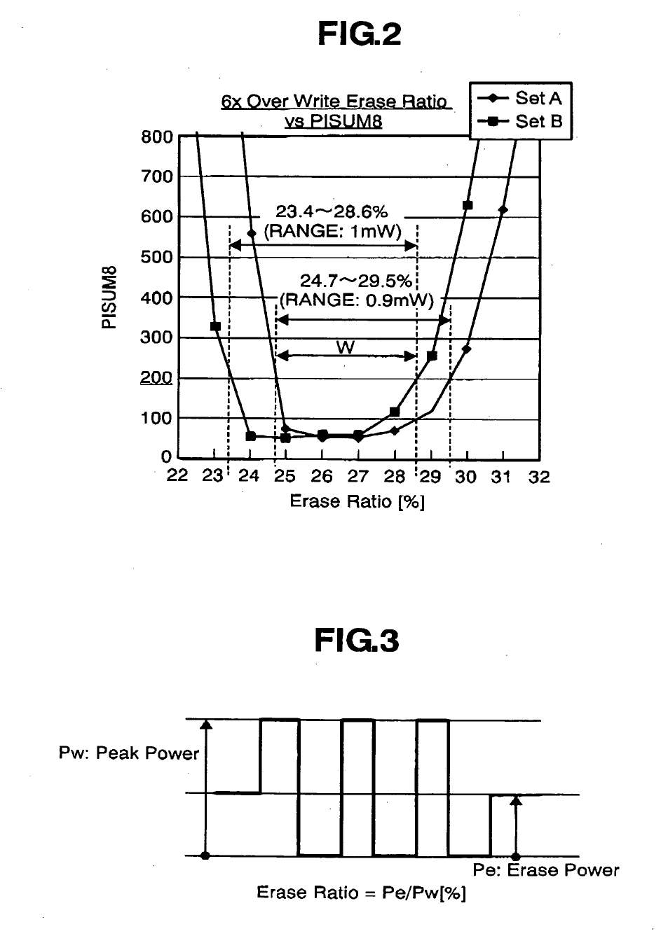

For example, FIG. 2 attached herewith shows the characteristics (i.e., Error Ratio Margin) when conducting the so-called self-overwrite operation (ICOW), by the apparatuses themselves, at the high-speed (6×), within two (2) products(i.e., a “Set A” and a “Set B”, for example) of the same model.

However, herein, the horizon axis (i.e., Erase Ratio) in this graph indicates, as will be explained by referring to FIG. 3 attached herewith, a ratio of the erasing power (Pe: Erase Power) to the maximum output (Pw: Peak Power) thereof (=Pe/Pw [%]), in the pulse-like shape (i.e., RW Disc Pulse pattern) of the laser beam (i.e., driving current), which is irradiated upon the disk when conducting the overwrite operation (ICOW) onto a RW (i.e., rewritable type) optical disk. On the other hand, the vertical axis thereof indicates a recording quality stabilizing region (i.e., PISUM 8: this indicating the Jitter characteristics). Further, in general, it is said that the recording quality can be stabilized is within the region where the value of the PISUM 8 shown on the vertical axis is equal or less than 200.

Again, turning back to FIG. 2 mentioned above, as is apparent from the characteristics shown in this figure, within the apparatuses of the same model, widths of the recording quality stabilizing regions thereof (i.e., “Set A”: 23.4-28.6% (region: 1 mW), and “Set B”: 24.7-29.5% (region: 0.9 mW)) are nearly equal to each other; however, the Erase Ratio (i.e., the position on the vertical axis) differs from each other. In this case, though there is no problem when conducting the self-overwrite operation by the same apparatus; however, in case when trying to conduct the self-overwrite operation upon data, which was recorded by the apparatus “Set A” on the RW (i.e., rewritable type) optical disk, by the apparatus “Set B” thereafter, for example, since the recording quality stabilizing regions of the respective apparatuses differ from each other in the Erase Ratio (i.e., the position on the vertical axis), therefore, the Erase Ratio where the recording can be conducted by the apparatus “Set B” with stable quality overlaps the recording quality stabilizing region of the apparatus “Set A” (this is shown by a mark “W” in the figure), and this means that the width (i.e., the margin) of Erase Ratio is narrowed.

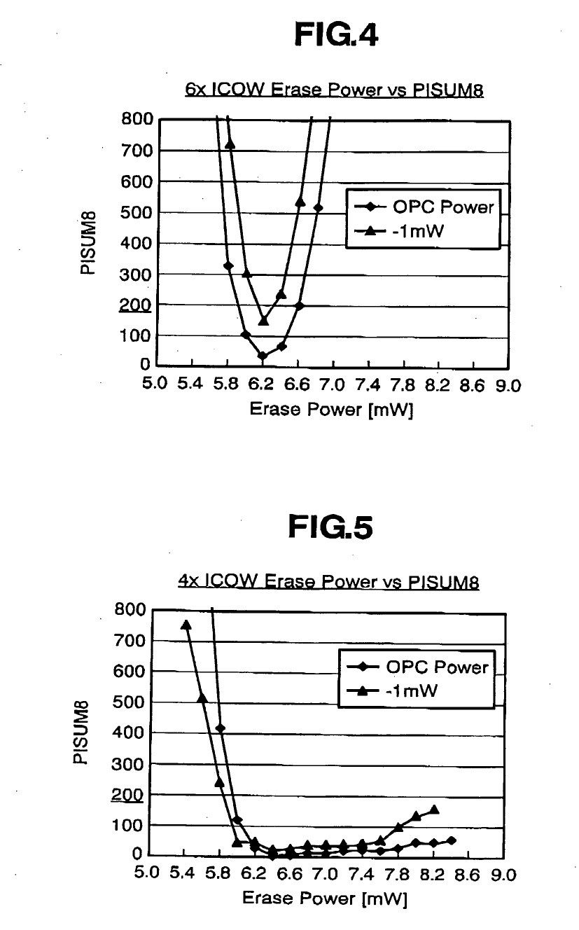

Further, such the fact as was mentioned above appears more remarkably, between the apparatuses (or products) differing from in the model thereof. For example, FIG. 4 attached herewith shows the characteristics, when the overwrite operation is conducted at the high-speed (6×) by the apparatuses differing in the model thereof, respectively. Thus, as is apparent from this graph, OPC is conducted within the apparatus, which tries to do the overwrite operation, and with the optimum power (i.e., POC Power in the figure) obtained from doing this, it is possible to obtain a certain recording quality stabilizing region, though it is narrow in the width thereof. However, in case when it get out from that optimum power a little bit (for example, at the power (−1 mW) lowering by −1 mW from the OPC Power, in the figure), the Erase Power still remaining within the recording quality stabilizing region (PISUM 8>200) comes to be very narrow in the width thereof (like a point), and with this, it is impossible to obtain the overwrite performances with stability and at high quality.

However, also in the case mentioned above, the characteristics when conducting the overwrite operation with lowering the recording speed (for example, at 4×) is shown in FIG. 5, and according to this, the width (i.e., the margin) of Erase Ratio becomes very wide; for this reason, it can be seen that it is possible to obtain the overwrite characteristics of high quality, with stability.

Then, according to the present invention, upon basis of such the knowledge by the present inventors, as was mentioned above in details thereof, i.e., when conducting the overwrite operation on the rewritable-type optical disk within the optical disk apparatus enabling the overwrite operation, first of all, determination is made on whether the said optical disk is recorded by other apparatus or not, upon basis of the RMD information recorded thereon, so that recording is made at the maximum speed thereof when determining that it is recorded by the apparatus itself. On the other hand, when determining that it is recorded by means of the apparatus other than that, recording is not made at the maximum speed, in particular, upon the optical disk, on which a deceleration request is registered, while registering it for each kind of the optical disks, i.e., on whether the recording should be made with deceleration or not when conducting the overwrite operation (ICOW ), in advance, into the memory device, such as, an EP-ROM or a Flash-ROM, etc., thereby enabling to avoid the problem accompanying with the overwrite operation onto the rewritable-type optical disk. However, in this instance, as was mentioned above, it is possible to determine the necessity of the deceleration, through confirming that the width (i.e., the margin) is sufficiently wide, while measuring the width (i.e., the margin) of the Erase Ratio for each kind of the optical disk.

For that reason, according to the present invention, for each ID of the rewritable-type optical disks (i.e., disk ID), verification is made on a recording strategy (such as, pulse condition, Peak Power/Erase Ratio), in advance, and it is registered into the memory device (such as, the EP-ROM or the Flash-ROM, etc. ) within the apparatus. Further, in this instance, it is also registered therein, at the same time, on whether the recording should be made with the deceleration or not when conducting the overwrite operation (ICOW).

On the other hand, where a start request for recording is made from the host after loading the disk into the apparatus, the disk ID is read out from the disk loaded therein, so as to set up the recording strategy mentioned above. And, upon basis of the RMD information, which is read out from the disk at the same time, determination is made on whether that information is recorded by the apparatus itself or not, and the recording is executed, dividing it into the following cases:
1) By the apparatus itself=>conduct recording at the maximum speed; and
2) The disk, on which the recording is made by the other apparatus, having the information of deceleration registration coincident with the disk ID within the apparatus=>conduct recording with deceleration.

With doing the above, it is possible to obtain stabilization when recording/reproducing.

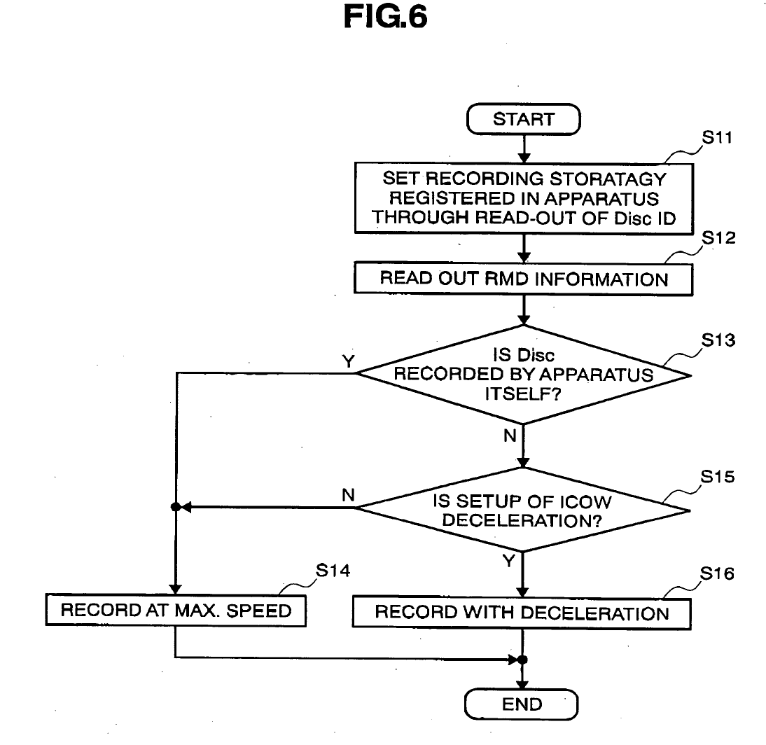

For the purpose of explaining the above in more details, in particular, when the optical disk apparatus, according to the one embodiment of the invention mentioned above, executes the recording operation, the control flow thereof will be shown in FIG. 6 attached herewith.

Thus, as is shown in the figure, when starting the recording operation upon the start request for recording from the host, for example, first of all, read-out is made upon the disk ID on the disk that is loaded therein, and thereby setting the recording strategy, which is registered in advice, into the optical disk apparatus (step S11). Thereafter, read-out is made upon the RMD information on the disk that is loaded in the apparatus (step S12). And, upon basis of the RMD information read out from the disk, determination is made on whether that disk is recorded by the apparatus itself or not (step S13). As a result thereof, in case when determining that it is recorded by the apparatus itself (“Y”) recording is conducted at the maximum speed (at 6× in the example mentioned above) of the optical disk apparatus (step S14), and thereby completing a series of steps of the control flow.

On the other hand, as the result of the step S13, in case when determining that it is not recorded by the apparatus itself (“N”), then next, determination is made on whether recording should be done with executing the deceleration or not when conducting the overwrite operation (ICOW) onto that disk, upon basis of the contents of setting registrations within the apparatus (step S15). As a result of this, in case where the deceleration is not set up (“N”) when conducting the overwrite operation (ICOW), recoding is conducted at the maximum speed (at 6× in the example mentioned above) of the optical disk apparatus (step S14), and thereby completing the series of steps of the control flow. On the contrary to this, in case where the deceleration is set up (“Y”) when conducting the overwrite operation (ICOW), as a result of the determination in the step S15 mentioned above, recording is done with executing the deceleration (at 4× in the example mentioned above) (step S16), and thereby completing the series of steps of the control flow.

In this manner, with the optical disk apparatus according to the present invention, in case where there is the information relating to the deceleration registered, which is coincident with the disk ID, recording is not conducted at the maximum speed. Thus, with using the fact that the Erase Power margin is widen through lowering the recording speed, it is possible to maintain the recording quality when conducting the overwrite operation (ICOW) even when there is variety or inequality between the optical disk apparatuses, which are different from each other, but within the same model.

As was fully mentioned above, according to the present invention, there can be obtain a superior effect of providing the optical disk apparatus and the control method for overwrite operation thereof, enabling the overwrite operation upon the re-writable optical disk, with maintaining the recording quality, sufficiently, even if the apparatus differs, including the case where there is variety or inequality in the recording performances among the optical disk apparatuses within the same model.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. An optical disk apparatus, for enabling overwrite operation upon a re-writable type optical disk, comprising:
a spindle motor for rotationally driving an optical disk of rewritable type, at a predetermined speed;
an information recording portion for recording information, through irradiating a laser beam upon an information recording surface of said optical disk of rewritable type, which is rotationally driven by said spindle motor;
an information reproducing portion for reproducing the information upon the information recording surface on said optical disk of rewritable type, through reflection light of the laser beam reflected upon the information recording surface thereof; and
a controller portion for controlling operation of said spindle motor, said information recording portion and said information reproducing portion, wherein
determination is made on whether information recorded on said re-writable type optical disk is conducted by said apparatus itself or not, when conducting the overwrite operation onto said re-writable type optical disk, and thereby conducting recording operation while driving said disk at a high speed within said apparatus, when determining that the information recorded on said re-writable type optical disk is conducted by said apparatus itself, on the other hand, conducting the recording operation while driving said disk at a speed lower than said high speed, when determining that the information recorded on said re-writable type optical disk is not conducted by said apparatus itself.

2. The optical disk apparatus, as described in the claim 1, wherein further determination is made on presence of setup for deceleration when conducting the overwrite operation, for a kind of said optical disk, when determining that the information recorded on said re-writable type optical disk is not conducted by said apparatus itself, and thereby conducting recording operation while driving said disk at the high speed within said apparatus, when determining that no setup is made for deceleration when conducting the overwrite operation, on the other hand, conducting the recording operation while driving said disk at a speed lower than said high speed, when determining that the setup is made for deceleration when conducting the overwrite operation.

3. The optical disk apparatus, as described in the claim 1, wherein the high speed within said apparatus is a maximum speed within said apparatus.

4. The optical disk apparatus, as described in the claim 2, wherein the high speed within said apparatus is a maximum speed within said apparatus.

5. The optical disk apparatus, as described in the claim 2, wherein the presence of the setup of deceleration for the kind of said optical disk when conducing the overwrite operation is determined upon basis of width of Erase Ratio within said apparatus.

6. The optical disk apparatus, as described in the claim 5, further comprising a memory device for memorizing the presence of the setup of deceleration when conducing the overwrite operation, which is determined, in advance.

7. The optical disk apparatus, as described in the claim 1, wherein determination is executed upon RMD information on said re-writable type optical disk, when determining on whether the information recorded on said re-writable type optical disk is recorded by said apparatus itself or not.

8. A method for controlling overwrite operation within an optical disk apparatus, for enabling the overwrite operation while rotationally driving a re-writable type optical disk at a predetermined speed, comprising the following steps of:
determining on whether information recorded on said re-writable type optical disk is recorded by said apparatus itself or not, when conducting the overwrite operation onto said re-writable type optical disk;
conducting recording operation while driving said disk at a high speed within said apparatus, when determining that the information recorded on said re-writable type optical disk is conducted by said apparatus itself in the above; and
conducting the recording operation while driving said disk at a speed lower than said high speed, on the other hand, when determining that the information recorded on said re-writable type optical disk is not conducted by said apparatus itself in the above.

9. The method for controlling overwrite operation within an optical disk apparatus, when determining that the information recorded on said re-writable type optical disk is not conducted by said apparatus itself in the above, further comprising the following steps of:
determining on presence of setup for deceleration when conducting the overwrite operation, for a kind of said optical disk;
conducting recording operation while driving said disk at the high speed within said apparatus, when determining that no setup is made for deceleration when conducting the overwrite operation; and
conducting the recording operation while driving said disk at a speed lower than said high speed, on the other hand, when determining that the setup is made for deceleration when conducting the overwrite operation.

10. The method for controlling overwrite operation within an optical disk apparatus, as described in the claim 8, wherein the high speed within said apparatus is a maximum speed within said apparatus.

11. The method for controlling overwrite operation within an optical disk apparatus, as described in the claim 9, wherein the high speed within said apparatus is a maximum speed within said apparatus.

12. The method for controlling overwrite operation within an optical disk apparatus, as described in the claim 9, wherein the presence of the setup of deceleration for the kind of said optical disk when conducing the overwrite operation is determined upon basis of width of Erase Ratio within said apparatus.
